(19) United States
(12) Patent Application Publication
(10) Pub. No.: US 2008/0212947 A1
(43) Pub. Date: Sep. 4, 2008

(54) Device For Handling Data Items That Can Be Rendered To A User

(75) Inventors: Jan Alexis, Daniel Nesvadba, Eindhoven (NL); Dzevdet Burazerovic, Eindhoven (NL); Cees Jan Mol, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,939

(22) PCT Filed: Oct. 3, 2006
(86) PCT No.: PCT/IB2006/053607

§ 371 Date: Apr. 2, 2008

(30) Foreign Application Priority Data
Oct. 5, 2005 (EP) 05300793.6

(51) Int. Cl. H04N 7/26

(52) U.S. Cl. 386/124

(57) ABSTRACT

A device (DVR) handles data items that can be rendered to a user. Such a device may be, for example, a digital video recorder. The device (DVR) comprises a network interface (NWIC, NWIM) that couples the device (DVR) to a network, which comprises other devices. A content analysis initiator (ECF) within the device (DVR) detects that another device, which forms part of the network, comprises a content analyzer. The content analysis initiator (ECF) causes the content analyzer (AVCA) of the other device to be applied to a data item (AVF).

### FIELD OF THE INVENTION

An aspect of the invention relates to a device for handling data items that can be rendered to a user, such as, for example, movies, video clips, still pictures, songs, and other kinds of sensorial data. The device may be, for example, a digital video recorder or any other type of electronic device that can form part of a network. Other aspects of the invention relate to a method of enhancing data items, a computer program product for a device that comprises a network interface, and a network of devices of which at least some have content analysis capabilities.

### DESCRIPTION OF PRIOR ART

The international patent application published under number 2004/090753 describes a system that includes a plurality of devices, which can communicate via a network. A server device includes a content directory service with a dynamic, hierarchical structure of containers. Each container is capable of storing objects. Each object includes an object description and an object content or an object content locator. The content directory service includes a predetermined upload container. The other devices in the system can make an object available via the content directory service to devices in the system by uploading the object to the predetermined container. The server determines a container in the content directory service for an uploaded object and moves the uploaded object to the determined container. The server determines the container based on the object description and/or object content.

### SUMMARY OF THE INVENTION

According to an aspect of the invention, a device, which handles data items that can be rendered to a user, has the following characteristics. The device comprises a network interface that couples the device to a network, which comprises other devices. A content analysis initiator detects that another device, which forms part of the network, comprises a content analyzer. The content analysis initiator causes the content analyzer of the other device to be applied to a data item.

The invention takes the following aspects into consideration. Modern data-handling devices allow a user to access a considerable quantity of data items such as, for example, movies, video clips, still pictures, songs, and other kinds of sensorial data. One reason for this is that modern data-handling devices have a relatively large data storage capacity. What is more, modern data-handling devices can form a network with other data-handling devices, which offer further data items. This may make it relatively difficult to find and retrieve a particular data item of interest. For example, a home network may comprise a digital video recorder, a digital audio set, and a personal computer, each of which is capable of storing a great number of data items.

Content descriptors allow a user to navigate in a collection of data items and to retrieve a particular data item more efficiently. For example, a content descriptor for a movie may comprise the following items: the title of the movie, the main actors that play in the movie, the producer of the movie, the year in which the movie was produced, and so on. Content descriptors may also indicate respective locations of particular scenes of interest within the movie. The user may be looking for a particular scene in a movie or a collection of movies. For example, the user may be interested to see car stunt scenes within a collection of movies. The richer the content descriptors are, the more easily the user can navigate and find what he or she is looking for.

Content descriptors can be entered manually. This is a rather cumbersome task. A content descriptor for a particular data item may already be available in an electronic form and in an appropriate format. For example, a television station may broadcast a movie and, in addition, a content descriptor for that movie. A digital video recorder may record the movie and, in association therewith, the content descriptor. As another example, a user who has recorded a movie on a digital video recorder may retrieve a content descriptor for that movie from another device in a network of which the digital video recorder forms part.

There are network protocols that allow a sharing of content description in a network. A set of network protocols known as “Universal Plug-and-Play” (UPnP) is an example. This set of network protocols provides for a function called “Content Directory Service”. The Content Directory Service gives one device in a network an overview of data items, as well as content descriptors associated therewith, comprised in another device that forms part of the network. The Content Directory Service simply assumes that a particular content descriptor is available or not; the function is not concerned with generation of content descriptors.

Content descriptors can be generated in an automatic, computerized fashion. For example, a device that handles video data may comprise a content analyzer in the form of a software module that recognizes a slow-motion repeat. A slow-motion repeat generally characterizes an interesting event, such as, for example, a goal in a football match. The content analyzer may also detect text in an image and extract that text, which becomes available as a string of characters. The content analyzer may further recognize that the text concerns a title role with descriptive information, such as, for example, actors' names. A sophisticated content analyzer may even comprise a face recognition algorithm, which is capable to recognize a person in an image.

In current concepts and scenarios that relate to networks of consumer electronic devices, content analysis and other forms of advanced data handling are typically assigned to a central server, or an external server, which disposes of considerable storage and processing capabilities. However, future consumer electronics devices may dispose of powerful content analysis capabilities of their own. For example, a next generation DVD recorder (DVD is an acronym for Digital Versatile Disk) may comprise a content analyzer that automatically detects interesting scenes and provides “intelligent chaptering” and even summarization. A future portable MP3 player (MP3 is an acronym for MPEG-2 layer 3 wherein MPEG is an acronym for Moving Picture Experts Group) may comprise a content analyzer that automatically classifies music and generates a play list.

In accordance with the aforementioned aspect of the invention, a device that handles data items, which can be rendered to a user, comprises a content analysis initiator. The content analysis initiator detects that another device, which forms part of the network, comprises a content analyzer. The content analysis initiator causes the content analyzer of the other device to be applied to the data item.

The invention allows a device, which forms part of a network, to exploit content analysis capabilities of other devices that form part of the network. The devices that form part of the network can effectively share their respective content analysis capabilities. For example, a data item that resides in one device can be submitted to another device for content analysis. This will generate one or more content description items, which the first mentioned device may not be capable of generating and which may not be available within the network. Consequently, the invention thus allows a greater set of content description items, which facilitates identification and retrieval of data items. For those reasons, the invention allows a more user-friendly handling of data items.

The invention allows a more user-friendly data handling also for the following reasons. The invention allows an automatic, spontaneous generation of content description items for a particular data item. Generating content description items for a particular data item does therefore not necessarily require a user intervention.

Another advantage of the invention relates to the following aspects. As mentioned hereinbefore, the invention allows that devices within a network can effectively share their respective content analysis capabilities. Consequently, there is no need for a central server with powerful content analysis capabilities, although the invention does not exclude such a central server. A central server is generally relatively expensive. In contradistinction, the invention allows a low-cost evolutionary approach. New content description items or improved content description items, or both, will be generated if a new device, which has additional content analysis capabilities, is added to the network. For those reasons, the invention allows low-cost implementations.

These and other aspects of the invention will be described in greater detail hereinafter with reference to drawings.

### BRIEF DESCRIPTION OF THE DRAWINGS

FIG. 1 is a conceptual diagram that illustrates a home network.

FIG. 2 is a block diagram that illustrates a digital video recorder, which forms part of the home network.

FIG. 3 is a flow chart that illustrates a series of steps that a network database manager, which resides in the digital video recorder, carries out.

FIG. 4 is a flow chart that illustrates a series of steps that a smart content assembly manager, which resides in the digital video recorder, carries out.

FIG. 5 is a flow chart that illustrates a series of steps that a content enhancement code, which resides in the digital video recorder, carries out.

FIG. 6 is a conceptual diagram that illustrates a migration of a smart content assembly in a universal plug-and-play architecture.

### DETAILED DESCRIPTION

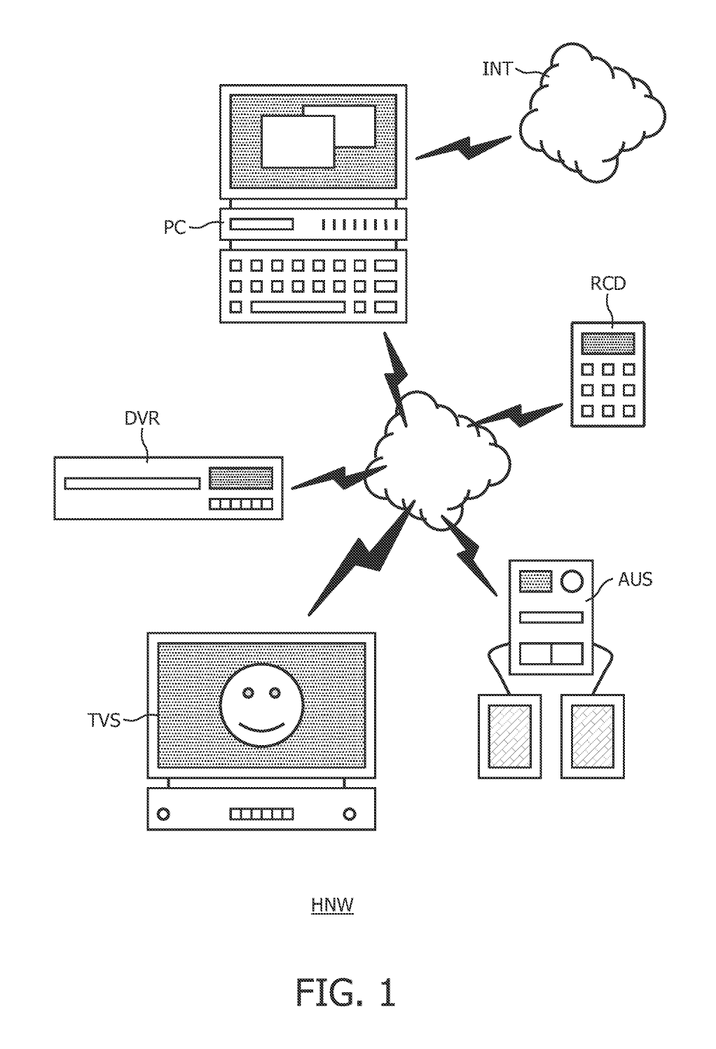

FIG. 1 illustrates a home network HNW. The home network HNW comprises various devices: a personal computer PC, a digital video recorder DVR, a television set TVS, an audio set AUS, and a remote control device RCD. The home network HNW may comprise further devices, which are not shown, such as, for example, a mobile phone, a set-top box and portable video player.

The devices that form part of the home network HNW can communicate with each other in accordance with, for example, a set of computer network protocols known as “Universal Plug-and-Play” (UPnP). A group of companies that is named “Universal Plug-and-play Forum” promulgates this set of computer network protocols. The personal computer PC may communicate with other devices, which may be located anywhere in the world, through the Internet INT. Accordingly, the personal computer PC can provide access to an external service that resides on a server on the Internet. Any other device that FIG. 1 illustrates may also communicate through the Internet or another type of communication network.

Each of the aforementioned devices may comprise a collection of audiovisual data items or any other type of sensorial data items. For example, various songs may be stored on a hard disk that forms part of the personal computer PC. The hard disk may also comprise still pictures, which have been taken by a digital still camera (DSC), video clips or even complete movies. The digital video recorder DVR may also comprise a hard disk on which movies, songs, and other forms of audiovisual data have been stored. The television set TVS may also comprise a storage medium with audiovisual data items. The same applies to the audio set AUS. What is more, each of the aforementioned devices may also comprise links that point to audiovisual data items that are stored on one or more other devices with which the device of interest can communicate. Such another device need not necessarily form part of the home network HNW.

A content descriptor may be associated with a particular audiovisual data item. For example, the following content description items may be associated with a movie: title, genre, main actors, and producer. The content descriptor may also comprise the following items: a scene-based segmentation of the movie, the length of the movie, the music, if any, within the movie, and so on. The content descriptor constitutes so-called metadata: data that provides information about other, basic data. Each device that comprises audiovisual data items may further comprise content descriptors for these audiovisual data items or may comprise links to content descriptors, or both.

Let it be assumed that the home network HNW, which FIG. 1 illustrates, is of the Universal Plug-and-Play type. In that case, any of the aforementioned devices may constitute a so-called control point. For example, the remote control device RCD may constitute a control point allowing a user to get an overview of audiovisual data items, which are available within the home network HNW. The user may select a particular audiovisual data item so as to have that audiovisual data item rendered. The respective content descriptors assist the user in this selection process. For example, the user may wish to know what football matches are available for viewing within the home network HNW. As another example, the user may wish to have an overview of all live concerts that are available within the home network HNW.

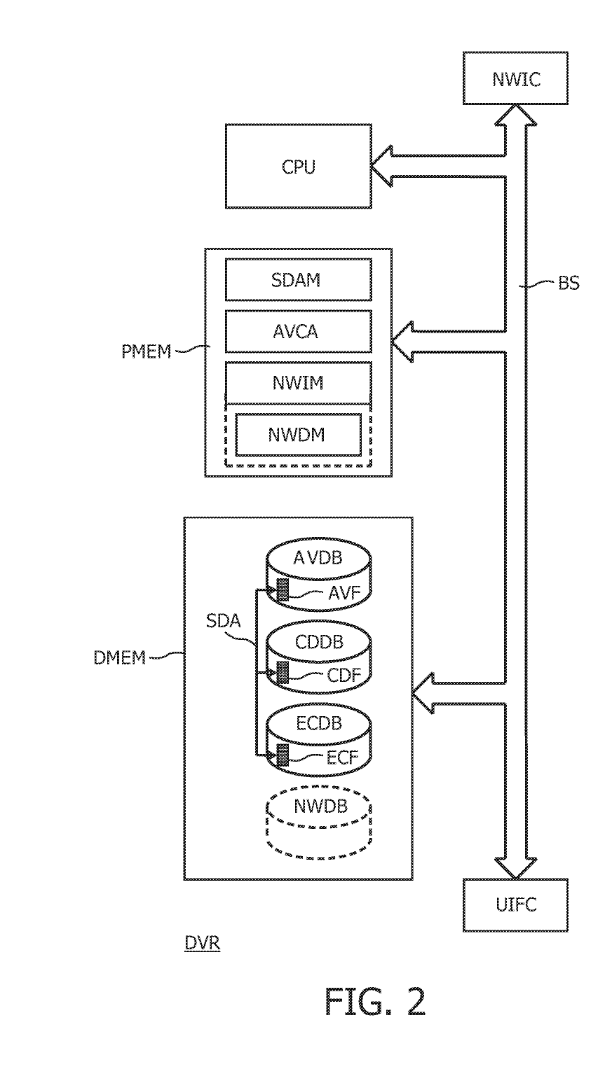

FIG. 2 illustrates the digital video recorder DVR. The digital video recorder DVR comprises a network interface circuit NWIC, a processing unit CPU, a program memory PMEM, a data memory DMEM, a user interface circuit UIFC, and a bus BS that allows the aforementioned elements to communicate with each other. The program memory PMEM may be in the form of, for example a nonvolatile semiconductor memory. The data memory DMEM may be in the form of, for example, a hard disk or a nonvolatile semiconductor memory, or a combination of both. The user interface circuit UIFC may comprise, for example, a display and a set of buttons. The network interface circuit NWIC may be, for example, of the universal serial bus type. The other devices in the home network HNW may have a structure similar to that illustrated in FIG. 2.

The program memory PMEM comprises various software modules: a smart data assembly manager SDAM, an audiovisual content analyzer AVCA, a network interface manager NWIM, and a network database manager NWDM. The network interface manager NWIM may be, for example, of the Universal Plug-and-Play type. Each software module comprises a set of instructions that causes the processing unit CPU to carry out one or more operations when the processing unit CPU executes the set of instructions. These operations will be described in greater detail hereinafter. The program memory PMEM may comprise further software modules that relate to recording operations, playback operations, and auxiliary operations.

The data memory DMEM comprises an audiovisual database AVDB, a content descriptor database CDDB, an enhancement code database ECDB, and a network database NWDB. The audiovisual database AVDB comprises an audiovisual file AVF that represents, for example, a movie. The audiovisual file AVF may have any appropriate format, such as, for example, an MPEG-4 format. It should be noted that the audiovisual file AVF may comprise a link that points to a storage location where the movie or portion thereof resides.

The content descriptor database CDDB comprises a content description file CDF that is associated with the aforementioned audiovisual file AVF. The content description file CDF may define various items in, for example, an extendable markup language. That is, the description file may be a so-called “XML” file (XML is an acronym for extendable markup language). The content description file CDF may be organized in a fashion that complies with, for example, the MPEG-7 standard or any other suitable standard; MPV, SMIL, MPEG-21, CC/PP are acronyms that designate other suitable standards.

The enhancement code database ECDB comprises an enhancement code file ECF that is associated with the aforementioned audiovisual file AVF and the aforementioned content description file CDF. The enhancement code file ECF comprises an executable code that allows an update of various items comprised in the content description file CDF. That is, the enhancement code file ECF allows an automatic enhancement of the content description file CDF that is associated with the audiovisual file AVF. This will be explained in greater detail hereinafter.

The audiovisual file AVF, the content description file CDF, and the enhancement code file ECF, which are associated with each other, constitute a smart data assembly SDA. Each of the aforementioned files may comprise an identification code that associates the file with the other files of the smart data assembly SDA. The smart data assembly manager SDAM supervises and manages the smart data assembly SDA. The smart data assembly manager SDAM may also have created the smart data assembly SDA. The smart data assembly SDA is capable of evolving in an independent, automatic fashion. The smart data assembly SDA is self-conscious, as it were, and seeks to enhance the content description file CDF. These aspects will be described in greater detail hereinafter.

The network database NWDB comprises a list with the devices that form part of the home network HNW, which FIG. 1 illustrates. In this list, each device has a so-called profile, which indicates various properties of the device. For example, the profile of the device can indicate that the device is capable of rendering MPEG-4 video data. A device may have various different capabilities in terms of handling and processing audiovisual data. The network database NWDB specifies these capabilities. FIG. 2 illustrates the network database NWDB in broken lines so as to emphasize that the network database NWDB need not necessarily reside within the digital video recorder DVR. The digital video recorder DVR may obtain information concerning the other devices that form part of the home network HNW from an external network database or by means of a querying technique. The other devices may also broadcast, as it were, their respective capabilities.

The audiovisual content analyzer AVCA, which is stored in the program memory PMEM, gives the digital video recorder DVR the following capability. The digital video recorder DVR can generate content description items for an audiovisual data item by analyzing, as it were, the audiovisual data item. These content description items, which the audiovisual content analyzer generates, may be included in the content descriptor database CDDB. For example, let it be assumed that the audiovisual content analyzer AVCA analyzes the audiovisual file AVF which FIG. 2 illustrates. The audiovisual content analyzer AVCA will generate content description items, which can be included in the content description file CDF that is associated with the audiovisual file AVF.

For example, the audiovisual content analyzer AVCA within the digital video recorder DVR can detect a scene within a football match that probably represents a goal or another interesting event. The audiovisual content analyzer AVCA may detect a slow motion repeat, which characterizes an interesting event in a football match. Such content analysis may be based on, for example, parameters that are generated while the audiovisual data item is being processed for purposes other than content analysis. The international application published under number WO 02/093928 describes this possibility. The audiovisual content analyzer AVCA may also detect text in an image and extract that text in the form of a string of alphanumeric characters. The text may concern a subtitle, a title role with the title of a program or movie and the actors therein, or news information.

The other devices that form part of the home network HNW may comprise software modules and data structures similar to those illustrated in FIG. 2. Consequently, one or more other devices that form part of the home network HNW, which FIG. 1 illustrates, may also have content analysis capabilities. These content analysis capabilities need not necessarily correspond with those of the digital video recorder DVR.

For example, the television set TVS may comprise a face recognition algorithm that allows identification of specific persons, which an audiovisual data item represents. The television set TVS may thus be capable of recognizing an actor in a movie, whereas the digital video recorder DVR does not have this capability. As another example, the audio set AUS may be capable of generating music descriptors, such as, for example, mood and genre of a particular piece of music, whereas the digital video recorder DVR does not have this capability.

As mentioned hereinbefore, the network database NWDB indicates capabilities of other devices, which form part of the home network HNW. Accordingly, the network database NWDB allows the smart data assembly SDA, which resides in the digital video recorder DVR, to be aware of content analysis capabilities of the other devices. One of the tasks of the network database manager NWDM is to keep the network database NWDB up-to-date.

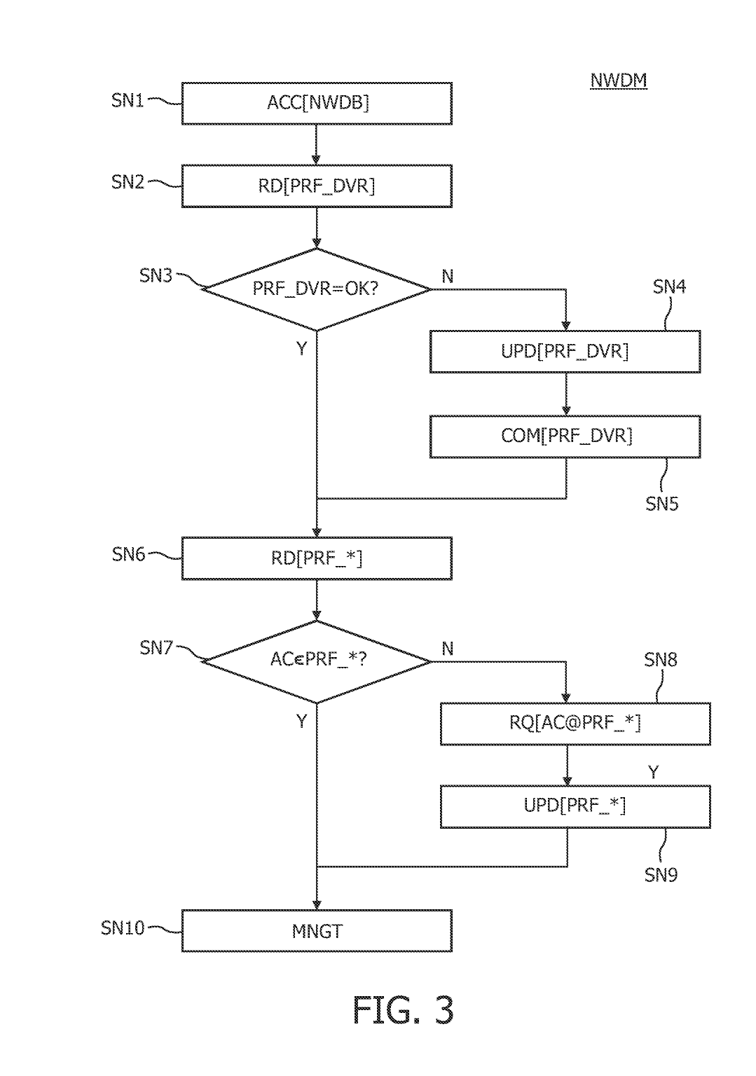

FIG. 3 illustrates a series of steps SN1-SN10, which the network database manager NWDM carries out. In step SN1, the network database manager NWDM accesses (ACC) the network database NWDB. In step SN2, the network database manager NWDM reads (RD) the profile of the digital video recorder DVR, which indicates various properties of the digital video recorder DVR including its content analysis capabilities.

In step SN3, the network database manager NWDM checks whether the profile of the digital video recorder DVR is up-to-date (PRF_DVR=OK?). This check may be based on a list of hardware modules and software modules that are present in the digital video recorder DVR. The digital video recorder DVR may have an operating system that provides such a hardware/software list and that modifies the list when a new software module is installed or a new hardware module is added. Conversely, the operating system may also modify the hardware/software list upon removal of a software module or a hardware module.

In step SN3, the network database manager NWDM compares the hardware/software list with the profile of the digital video recorder DVR in the network database NWDB. Let it be assumed that the network database manager NWDM finds that the profile does not correspond (output N) with the hardware/software list. In that case, the network database manager NWDM carries out step SN4 and, optionally, step SN5.

In step SN4, the network database manager NWDM updates (UPD) the profile digital video recorder DVR in the network database NWDB so that the profile, when updated, corresponds with the hardware/software list. In step SN5, which is optional, the network database manager NWDM communicates (COM) the profile of the digital video recorder DVR, which has been updated, to the other devices in the home network HNW. Accordingly, the other devices are aware of the fact that the properties of the digital video recorder DVR have changed.

For example, each other device may comprise a network database NWDB similar to the network database NWDB in the digital video recorder DVR that FIG. 2 illustrates. In that case, the network database manager NWDM causes the profile of the digital video recorder DVR, which has been updated, to be copied to the respective network databases of the other devices. Accordingly, each device can have an up-to-date view of the content analysis capabilities that other devices provide. Alternatively, there may be a single central network database NWDB within the home network HNW. In that case, step SN5 can be omitted.

It should be noted that a device may be off-line and, therefore, temporarily unavailable. There are various mechanisms to cope with this as to ensure that each device is aware of the content analysis capabilities of the other devices, even when one or more devices are off-line. For example, a device that has been off-line can broadcast, as it were, its content analysis capabilities to the other device as soon as the device is on-line again. Such a mechanism can be similar to that of an e-mail application that keeps messages in an outbox and that sends those messages as soon as the device, on which the e-mail application resides, is switched on. A mechanism similar to that of an e-mail inbox can be used so as to ensure that a device, which has been off-line, is aware of the content analysis capabilities of other devices as soon as the device is on-line again. Accordingly, the network database NWDB can indicate all potentially available content analysis capabilities within the home network HWN.

A mechanism, which ensures that each device is aware of the content analysis capabilities of the other devices, may also be based on one or more Universal Plug and Play protocols. The Simple Service Discovery Protocol (SDDP) is a suitable protocol. In accordance with this protocol, each device with content analysis capabilities could multicast appropriate SDDP messages via the home network HNW so as to inform the other devices about these capabilities. These SDDP messages could be sent as data packets according to some standard communication protocol, such as, for example the User Datagram Protocol (UPD). These data packets would then have SDDP headers.

In step SN6, the network database manager NWDM reads the respective profiles of the other devices that form part of the home network HNW. In step SN7, the network database manager NWDM checks each profile so as to determine whether the device to which the profile relates has content analysis capabilities (AC). The network database manager NWDM carries out step SN8 if the profile does not specify any content analysis capabilities.

In step SN8, the network database manager NWDM establishes a communication with the device concerned or another entity that comprises up-to-date information about the capabilities of the device concerned. The network database manager NWDM requests (RQ) up-to-date information about the content analysis capabilities of the device concerned. In step SN9, the network database manager NWDM updates the profile of the device concerned in the network database NWDB that the network database manager NWDM manages.

In step SN10, the network database manager NWDM carries out other management tasks, if any (MNGT). Accordingly, FIG. 3 illustrates a method that allows each device in the home network HNW to have up-to-date information about the content analysis capabilities of the other devices. There are numerous alternative methods to achieve the same. For example, a device can broadcast a request for certain content analysis capabilities, like a so-called “ping”. It should also be noted that services on the Internet could provide requested content analysis capabilities. Such a service could transfer content analysis software to a requesting device in a downstream fashion, so that the requesting device can locally execute the content analysis software.

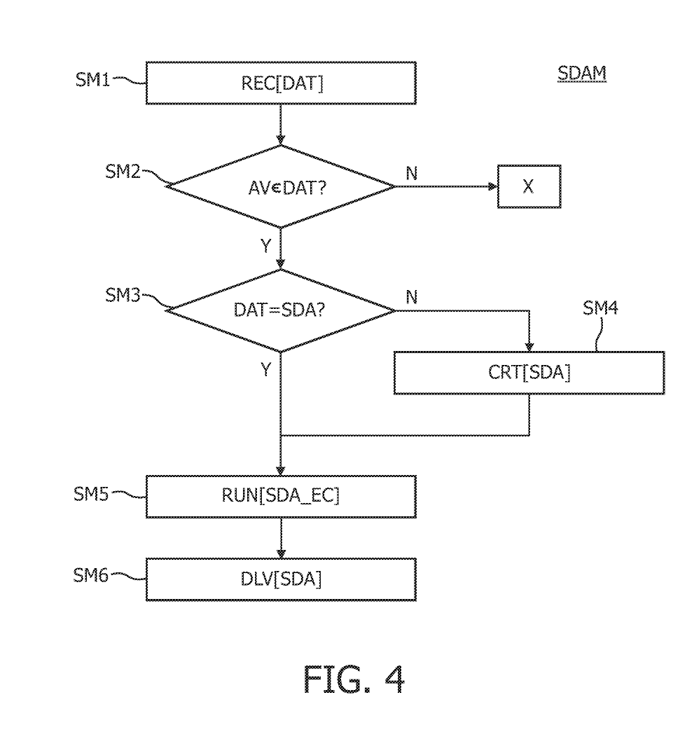

FIG. 4 illustrates a series of steps SM1-SM6 that the smart data assembly manager SDAM carries out. In step SM1, the digital video recorder DVR receives data (REC[DAT]), which event activates the smart data assembly manager SDAM. Other events may also activate the network smart data assembly manager SDAM. In step SM2, the smart data assembly manager SDAM determines whether the data, which the digital video recorder DVR receives, comprises audiovisual (AV) data. The smart data assembly manager SDAM goes in an idle mode if the data does not comprise any audiovisual data. A relatively small box that comprises an “X” symbolizes the idle mode. The smart data assembly manager SDAM carries out step SM3 if there is audiovisual data.

In step SM3, the smart data assembly manager SDAM determines whether the audiovisual data forms part of a smart data assembly (SDA), which further comprises a content description data and an enhancement code. Let it be assumed that the audiovisual data does not form part of a smart data assembly. For example, the digital video recorder DVR may be recording a television program that is broadcasted without any supplementary information. In that case, the smart data assembly manager SDAM carries out step SM4.

In step SM4, the smart data assembly manager SDAM creates (CRT) a smart data assembly for the audiovisual data received. To that end, the smart data assembly manager SDAM generates a template for content description data and retrieves a suitable enhancement code. The template preferably complies with a standard for content description data, such as, for example, MPEG-7. In general, the template will comprise various fields for various different description data items. For example, one field may be reserved for a title, another field may be reserved for an actor or a performer, yet another field may be reserved for bookmark-like information, which points to a particular event within the audiovisual data. Let it be assumed that the audiovisual data, which the digital video recorder DVR receives, does not comprise any content description data. In that case, the smart data assembly manager SDAM creates, in step SM4, a smart data assembly with an “empty” content descriptor. Stated more precisely, the fields of the content descriptor are empty.

The content descriptor will generally have a profile, which determines the number of fields and the meaning of each respective field. The profile may change over time. The profile may also define that a particular field has one or more attributes, which provide supplementary information about the content description item comprised in the field. For example, let it be assumed that the profile provides that the content descriptor comprises a field that is reserved for an actor's name. Such a field may have an attribute that specifies a face recognition algorithm, which has been employed to establish the actor's name. Another attribute may specify the version of the face recognition algorithm that has been used.

A content descriptor may comprise multiple fields that relate to the same content description item. For example, various different face recognition algorithms may have been applied to a movie in order to identify actors. The content description may comprise an actor-names field for each face recognition algorithm, with attributes for each of those fields. The attributes may indicate, for example, the face recognition algorithm that has been used, the hardware that was involved, the date when the algorithm was applied, and so on. The attributes of a field thus provide context information that can be used to evaluate the quality of the data in the field. It should further be noted that preserving results from content analysis algorithms that have previously been carried out allows backward compatibility.

In step SM5, the smart data assembly manager SDAM causes the processing unit CPU of the digital video recorder DVR to execute (RUN) the enhancement code, which forms part of the smart data assembly. As a result, the smart data assembly SDA will seek to fill in the fields of the content descriptor, which forms part of the smart data assembly. Accordingly, step SM5 will produce an enhanced smart data assembly, which is richer in information. For example, let it be assumed that there are no content description items available yet for the audiovisual data that the digital video recorder DVR receives. In that case, the smart data assembly may activate the audiovisual content analyzer AVCA within the digital video recorder DVR illustrated in FIG. 2. The audiovisual content analyzer AVCA will generate content description items, which the smart data assembly will include in its content descriptor.

In step SM6, the smart data assembly manager SDAM delivers (DLV) the enhanced smart data assembly to the device of interest, which is the digital video recorder DVR in this case. The enhanced smart data assembly will thus be stored in the data memory DMEM, which FIG. 2 illustrates.

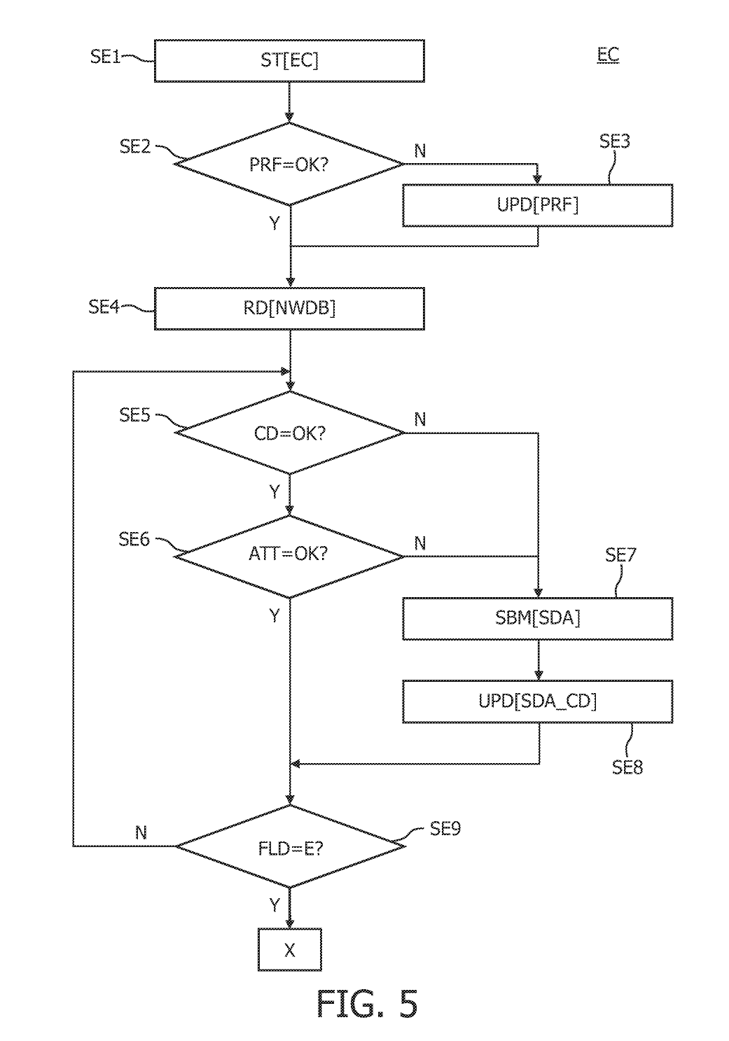

FIG. 5 illustrates various steps SE1-SE9 that are carried out when an enhancement code EC is executed. The enhancement code EC may be, for example, the code comprised in the enhancement code file ECF that belongs to the smart data assembly SDA, which FIG. 2 illustrates. This will be assumed to be the case hereinafter.

In step SE1, the enhancement code is activated (ST[EC]). In step SE2, the enhancement code checks (PRF=OK?) whether the content description file CDF comprises a content descriptor whose profile is up-to-date. As mentioned hereinbefore, the profile may change over time. A new profile may comprise a field, which was not present in a previous profile. For example, a new profile may comprise a field that constitutes a parental control indicator, whereas such a field was not foreseen in a previous profile.

There are various manners in which the enhancement code may be aware of, as it were, the existence of a new profile. For example, the enhancement code may interrogate a database that comprises most recent profiles for various types of content descriptors. The network database NWDB may comprise an overview of all the profiles of the content descriptors that the devices, which form part of the home network HNW, can generate. In this example, the enhancement code may interrogate the network database NWDB so as to check whether there is a profile that allows a richer content description.

Let it be assumed that, in step SE2, the enhancement code establishes that the profile is not up-to-date (output N): there is a more recent profile. In that case, the enhancement code carries out step SE3. In this step, the enhancement code updates the profile, which allows a content descriptor that is richer in information.

In step SE4, the enhancement code accesses (RD) the network database NWDB. Accordingly, the smart data assembly SDA, of which the enhancement code forms part, acquires knowledge about the content analysis capabilities of the devices that form part of the home network HNW. Subsequently, the enhancement code carries out steps SE5 and SE6 for each consecutive field in the content descriptor. In step SE9, the enhancement code checks whether a current field (FLD) for which steps have been carried out is the last field of the content descriptor. The enhancement code goes in an idle mode if the current field is the last field. Steps SE5 and SE6 are carried out a new for a subsequent field if the current field is not the last field.

In step SE5, the enhancement code checks (CD=OK?) whether the field of interest comprises any meaningful content description item for which the field has been reserved. The field of interest is considered to be OK (output Y) if the field of interest comprises a meaningful content description item. In that case, the enhancement code carries out step SE6. The enhancement code carries out steps SE7 and SE8 if the field of interest is considered not to be OK.

In step SE6, the enhancement code examines the attributes (ATT), if any, which belong to the field of interest. As mentioned hereinbefore, the attributes provide supplementary information about the content description item, which the field of interest comprises. In step SE6, the enhancement code determines whether the content description item is up-to-date by comparing the attributes with the respective profiles of the respective devices. These profiles are stored in the network database NWDB.

Let it be assumed, for example, that the content description item indicates actors and that an attribute indicates the face recognition algorithm that has been employed to recognize these actors. The network database NWDB may indicate that the home network HNW comprises a device that has a more recent version of the face recognition algorithm. In that case, the enhancement code determines that the content description item needs an update. The enhancement code subsequently carries out steps SE7 (submit SBM) and SE8 (update UPD).

In step SE7, the enhancement code causes the digital video recorder DVR to submit the smart data assembly SDA to a device that is capable of enhancing the smart data assembly. This device will be referred to as service providing device hereinafter because the device renders a service to the digital video recorder DVR by enhancing the smart data assembly SDA comprised therein. The enhancement code has identified the service providing device in step SE5 or step SE6. In step SE5, the enhancement code identifies the service providing device that is capable of generating a content description item for the field of interest, which was found to be empty. In step SE6, the enhancement code identifies the service providing device that is capable of updating the content description item, which was found to be insufficiently up-to-date. In either case, the smart data assembly SDA is submitted to the service providing device that is capable of enhancing the content descriptor.

The service providing device will enhance the smart data assembly SDA upon receipt of the smart data assembly SDA. For example, the service providing device may comprise a smart data assembly manager that is similar to the smart data assembly manager SDAM illustrated in FIGS. 2 and 4. The smart data assembly manager of the service providing device may detect that the receipt of the smart data assembly SDA concerns an enhancement request. This smart data assembly manager may then cause one or more audiovisual content analyzers, which are comprised in the service providing device, to be applied to the audiovisual data of the smart content assembly SDA. Each audiovisual content analyzer will generate one or more content description items, which are missing in the content descriptor of the smart data assembly SDA, or which are insufficiently up-to-date, whichever is the case.

The enhancement code of smart data assembly SDA, which has migrated to the service providing device, can add the content description items that have been generated to the content descriptor. Accordingly, the smart data assembly SDA is enhanced. The service providing device may then return the smart data assembly SDA, which has been enhanced, to the digital video recorder DVR.

The enhancement code of a smart data assembly can be implemented as a so-called software agent. A software agent can be regarded as an autonomous process that is capable of reacting to its environment and initiating changes, possibly in collaboration with other software agents and user commands. A software agent has the capability to act on its own and, in particular, to take initiative wherever appropriate. The book entitled “Distributed Systems—Principles and Paradigms” by Andrew S. Tanenbaum and Maarten van Steen, published as by Prentice-Hall Inc. (ISBN 0-13-088893-1) describes software agents and architectures related to software agents. It should be noted that a software agent is typically not associated with any data on which the software agents perform actions. In contradistinction, an enhancement code of a smart data assembly is typically associated with a content descriptor and audiovisual data, which also form part of the smart data assembly.

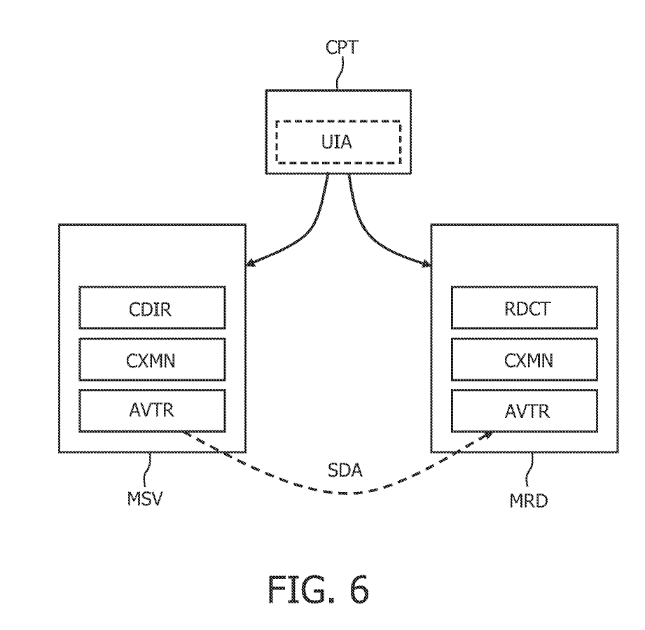

FIG. 6 illustrates a migration of the smart data assembly SDA in a Universal Plug-and-Play architecture. The Universal Plug-and-Play architecture comprises the following basic functions: a media server MSV, a media renderer MRD, and a control point CPT. These functions allow communication of audiovisual data between the devices that form part of the home network HNW, which FIG. 1 illustrates. The media server MSV is a source of audiovisual data in a particular communication session. The media renderer MRD is the destination. In principle, any device may carry out one or more of the aforementioned functions so as to form the source or the destination.

FIG. 6 illustrates a case in which the digital video recorder DVR constitutes the media server MSV, which is the source of the smart data assembly SDA. The control point CPT, which controls the communication session, may reside in, for example, the remote control device RCD or in the digital video recorder DVR itself. The control point CPT generally comprises a user interface application UIA. The aforementioned service providing device constitutes the media renderer MRD, which is the destination of the smart data assembly SDA. In the case that FIG. 6 illustrates, the smart data assembly SDA migrates from the digital video recorder DVR to the service providing device.

The media server MSV comprises the following sub-functions, which are often referred to as “services”: a content directory CDIR, a connection manager CXMN, and an audiovisual transport AVTR. The media renderer MRD also comprises the connection manager CXMN, the audiovisual transport AVTR, and an additional sub-function: a rendering control RDCT. The content directory CDIR lists audiovisual data items that are available on the media server MSV. The content directory CDIR further lists so-called metadata, which includes content descriptors that are available on the media server MSV.

In accordance with the invention, the content directory CDIR as specified by the Universal Plug-and-Play forum is extended so that the metadata specifies content analysis capabilities of the media server MSV. Such an extension of the content directory CDIR allows a device in a Universal Plug-and-Play type of network to be aware of the content analysis capabilities of other devices that form part of the network.

The connection manager CXMN selects appropriate formats and protocols for the communication session between the media server MSV and the media renderer MRD. For example, the CC/PP protocol is suitable for communicating content analysis capabilities (CC/PP is an acronym for Composite Capability/Preference Profiles). In technical terms, the CC/PP protocol is a so-called RDF-based format for describing and managing software and hardware profiles (RDF is an acronym for Resource Description Framework). These profiles may include information on respective capabilities of two communication partners, one of which is a source while the other is a destination.

The audiovisual transport AVTR provides a mechanism that allows the control point CPT to control the migration of the smart data assembly SDA from the digital video recorder DVR to the service providing device. The migration occurs in what is called an “out-of-band streaming” in Universal Plug-and-Play terminology. The audiovisual transport AVTR is related to the connection manager CXMN.

### Concluding Remarks

The detailed description hereinbefore with reference to the drawings illustrates the following characteristics, which are cited in various independent claims. A device (DVR), which handles data items that can be rendered to a user, comprises a network interface (NWIC, NWIM) that couples the device (DVR) to a network (HNW), which comprises other devices (PC, TVS, AUS, RCD). A content analysis initiator (ECF) within the device (DVR) detects that another device (PC, TVS, AUS, RCD), which forms part of the network (HNW), comprises a content analyzer (AVCA). The content analysis initiator (ECF) causes the content analyzer (AVCA) of the other device to be applied to the data item (AVF).

The detailed description hereinbefore further illustrates various optional characteristics, which are cited in the dependent claims. These characteristics may be applied to advantage in combination with the aforementioned characteristics. Various optional characteristics are highlighted in the following paragraphs. Each paragraph corresponds with a particular dependent claim.

The content analysis initiator (ECF) examines whether a content descriptor (CDF) for a data item (AVF) comprises an empty field, which has been reserved for a particular content description item. In addition, the content analysis initiator (ECF) examines whether another device (PC, TVS, AUS, RCD) that forms part of the network (HNW) comprises a content analyzer (AVCA) susceptible of generating the particular content description item. If so, the content analysis initiator causes the content analyzer (AVCA) of the other device to be applied to the data item (AVF). This set of characteristics allows content description items to be generated in a relatively efficiency manner.

The content analysis initiator (ECF) examines an attribute of a content description item in a content descriptor (CDF) for a data item (AVF) so as to establish whether another device (PC, TVS, AUS, RCD) that forms part of the network (HNW) comprises a content analyzer (AVCA) susceptible of generating an improved content description item. If so, the content analysis initiator (ECF) causes the content analyzer (AVCA) of the other device to be applied to the data item (AVF). This set of characteristics allows content description items to be generated in a relatively efficiency manner.

The content analysis initiator (ECF) examines whether the content descriptor (CDF) has a profile that is up-to-date. If not, the content analysis initiator (ECF) updates the profile of the content descriptor (CDF). This will incite the content analysis initiator to add new or improved content description items to the content descriptor.

The content analysis initiator (ECF) accesses a network database (NWDB) that comprises a list of devices, which form part of the network (HNW), and their respective content analysis capabilities. This allows content description items to be generated in a relatively efficiency manner.

A smart content assembly manager (SCAM), not shown, associates the content analysis initiator (ECF) with the data item (AVF). This allows different content analysis initiators for different data items, which may have different formats. The smart content assembly manager (SCAM) creates a template for a content descriptor (CDF) upon receipt of a data item from another device (PC, TVS, AUS, RCD). This will incite the content analysis initiator to add content description items to the content descriptor, which is “empty”.

The network interface (NWIC, NWIM) is of the universal plug-and-play type and comprises an extended content directory (CDIR) that specifies content analysis capabilities of the device (DVR). This allows low-cost implementations.

The aforementioned characteristics can be implemented in numerous different manners. In order to illustrate this, some alternatives are briefly indicated.

There are numerous different types of data items that can be rendered to a user. Movies, video clips, still pictures, and songs are merely examples. A data item may comprise any kind of sensorial data. All what matters is that a data item has content with certain characteristics, which can be described or categorized.

There are numerous different types of devices that can handle data items, which can be rendered to a user. A digital video recorder, a personal computer, a television set, and an audio set are merely examples. A cellular phone, a settop box and a personal digital assistant are other examples of such devices. There are many types of networks that allow a content analyzer, which resides in one device, to be applied to a data item, which resides in another device. A home network is merely an example of such a network. It should further be noted that there are numerous different types of network interfaces that allow devices to communicate with each other. A network interface of the universal plug and play type is merely an example.

The content analysis initiator can be implemented in numerous different manners. The detailed description hereinbefore merely describes an example in which an enhancement code, which is associated with a data item, initiates content analysis. As another example, a smart content assembly manager may initiate content analysis. The smart content assembly manager may carry out one or more steps that FIG. 5 illustrates. There are various manners in which a content analysis initiator can cause a content analyzer, which resides in one device, to be applied to a data item, which resides in another device. The detailed description provides an example in which a data item is submitted to a device that comprises a content analyzer. Alternatively, a device that comprises a data item can borrow, as it were, a content analyzer in the form of a software program from another device.

There are numerous different manners in which device in accordance with the invention can detect that another device has content analysis capabilities. The detailed description provides an example that involves a network database. A network database is not essential. For example, a device may query other devices that form part of network so as to gather information about content analysis capabilities of the other devices. This can be regarded as a pull scenario. In a push scenario, each device broadcasts as it were its content analysis capabilities to the other devices. Any type of communication may be used for the purpose of communicating content analysis capabilities. For example, a device, which has content analysis capabilities, may send an e-mail to another device so as to inform information that other device of its content analysis capabilities.

Content descriptors can have numerous different forms. FIG. 2 illustrates an example in which the content description file CDF comprises a content description of audiovisual data in an audiovisual file AVF. As another example, a content description can be merged with audiovisual data so as to form a single file that comprises annotated audiovisual data.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A device (DVR) for handling data items that can be rendered to a user, the device comprising:
a network interface (NWIC, NWIM) arranged to couple the device (DVR) to a network (HNW) that comprises other devices (PC, TVS, AUS, RCD); and
a content analysis initiator (ECF) arranged to detect that another device (PC, TVS, AUS, RCD), which forms part of the network (HNW), comprises a content analyzer (AVCA) and to cause the content analyzer (AVCA) of the other device to be applied to a data item (AVF).

2. A device (DVR) according to claim 1, the content analysis initiator (ECF) being arranged to examine whether a content descriptor (CDF) of a data item (AVF) comprises an empty field, which has been reserved for a particular content description item, and to examine whether another device (PC, TVS, AUS, RCD), which forms part of the network (HNW), comprises a content analyzer (AVCA) susceptible of generating the particular content description item and, if so, to cause the content analyzer (AVCA) of the other device to be applied to the data item (AVF).

3. A device (DVR) according to claim 1, the content analysis initiator (ECF) being arranged to examine an attribute of a content description item in a content descriptor (CDF) of a data item (AVF) so as to establish whether another device (PC, TVS, AUS, RCD), which forms part of the network (HNW), comprises a content analyzer (AVCA) susceptible of generating an improved content description item and, if so, to cause the content analyzer (AVCA) of the other device to be applied to the data item (AVF).

4. A device (DVR) according to claim 2, the content analysis initiator (ECF) being arranged to examine whether the content descriptor (CDF) has a profile that is up-to-date and, if not, to update the profile of the content descriptor (CDF).

5. A device (DVR) according to claim 1, the content analysis initiator (ECF) being arranged to access a network database (NWDB) that comprises a list of devices that form part of the network (HNW) and their respective content analysis capabilities.

6. A device (DVR) according to claim 1, the content analysis initiator (ECF) being arranged to cause the data item (AVF) to be submitted to the other device (PC, TVS, AUS, RCD) for content analysis.

7. A device (DVR) according to claim 1, the device (DVR) comprising:
a smart content assembly manager (SCAM) arranged to associate the content analysis initiator (ECF) with the data item (AVF).

8. A device (DVR) according to claim 7, the smart content assembly manager (SCAM) of the device (DVR) being arranged to create a template for a content descriptor (CDF) upon receipt of a data item from another device (PC, TVS, AUS, RCD).

9. A device (DVR) according to claim 1, the network interface (NWIC, NWIM) being of the universal plug-and-play type.

10. A device (DVR) according to claim 9, the network interface (NWIC, NWIM) comprising an extended content directory (CDIR) that specifies content analysis capabilities of the device (DVR).

11. A method of enhancing data items that can be rendered to a user, the data items being stored in a device (DVR) that comprises a network interface (NWIC, NWIM), which couples the device (DVR) to a network (HNW) that comprises other devices (PC, TVS, AUS, RCD),
the method comprising:
a content analysis initiating step in which the device (DVR) executes an enhancement code (EC) so as to detect that another device (DVR), which forms part of the network (HNW), comprises a content analyzer (AVCA) and causes the content analyzer (AVCA) of the other device to be applied to a data item (AVF).

12. A computer program product (EC) for a device (DVR) that comprises a network interface (NWIC, NWIM) arranged to couple the device (DVR) to a network (HNW) that comprises other devices (PC, TVS, AUS, RCD),
the computer program product (EC) comprising a set of instructions that causes the device (DVR) to carry out:
a content analysis initiating step in which the device (DVR) detects that another device (PC, TVS, AUS, RCD), which forms part of the network (HNW), comprises a content analyzer (AVCA) and causes the content analyzer (AVCA) of the other device to be applied to a data item (AVF) that can be rendered to a user.

13. A network (HNW) of devices of which at least some have content analysis capabilities, the network (HNW) comprising a device (DVR) according to claim 1.
